(19) United States
(12) Patent Application Publication
(10) Pub. No.: US 2017/0273872 A1
(43) Pub. Date: Sep. 28, 2017

(54) BABY FORMULA CONSUMPTION BOTTLE

(71) Applicant: Courtney Jones, Gadsden, AL (US)

(72) Inventor: Courtney Jones, Gadsden, AL (US)

(21) Appl. No.: 15/080,782

(22) Filed: Mar. 25, 2016

(51) Int. Cl. A61J 9/00; A61J 9/08

(52) U.S. Cl. CPC A61J 9/008; A61J 9/085

(57) ABSTRACT

A bottle for baby formula that includes: a main liquid portion; a formula portion attached to the liquid portion, where the formula portion includes an infant formula for consumption and is adapted for removal; an attachment means that provides a means to attach the formula portion to the liquid portion of the bottle; a nipple; and a removable cap, where the removable cap covers the nipple. Preferably, the attachment means is a threaded connection and the liquid portion includes a curved outer surface. The infant formula may be a premixed powder mixable with water.

### BACKGROUND OF THE INVENTION

### Field of Invention

The present invention relates to a bottle designed for infant and baby formula consumption.

### Description of Related Art

It is well known babies and infants are fed liquids in the form of formula or mother's breast milk while in their infancy. After a baby's birth the initial food source is essentially this formula that helps to nourish and allow them to grow until the infant is able to consume more solid foods. The infant may be fed through breast milk, which requires the mother's nursing with her own breast milk. Occasionally this milk may be stored for later use however the primary source is the mother's breast for nursing purposes. Other parents choose to feed their children through the use of premixed baby formulas. Typically these formulas may come in a liquid or a powder form and are mixed with water for consumption by the infant. If the formula requires mixing it can be difficult to transport the necessary items such as the bottles of the formula and water for consumption as needed. Some parents choose premixed baby formula but this formula must be consumed immediately or stored in a cooling container to avoid spoilage. As a result, it would be advantageous to have a bottling system that includes prepackaged, premixed formula that is ready for mix direct consumption by an infant.

### SUMMARY OF THE INVENTION

The present invention relates to a bottle for baby formula that includes: a main liquid portion; a formula portion attached to the liquid portion, where the formula portion includes an infant formula for consumption and is adapted for removal; an attachment means that provides a means to attach the formula portion to the liquid portion of the bottle; a nipple; and a removable cap, where the removable cap covers the nipple. Preferably, the attachment means is a threaded connection and the liquid portion includes a curved outer surface. The infant formula may be a premixed powder mixable with water.

### BRIEF DESCRIPTION OF DRAWINGS

FIG. 1 depicts a bottle in accordance with the present invention.

### DETAILED DESCRIPTION

The present invention relates to a bottle, in particular, a baby bottle that is designed for mixing and storing baby formula. The bottle includes a storage compartment that stores formula in a powder form that is accessible and removable from the main portion of the bottle. This formula may be mixed with water within the main compartment of the bottle so that it may be utilized for feeding an infant as needed. The bottle includes a curved ergonomic shape for easy handling and a clear cap that covers the nipple on the bottle. The bottle as a result may include both water within a main compartment and baby formula in a separate compartment that is released and mixed with the water at the desired time by the parent or caregiver.

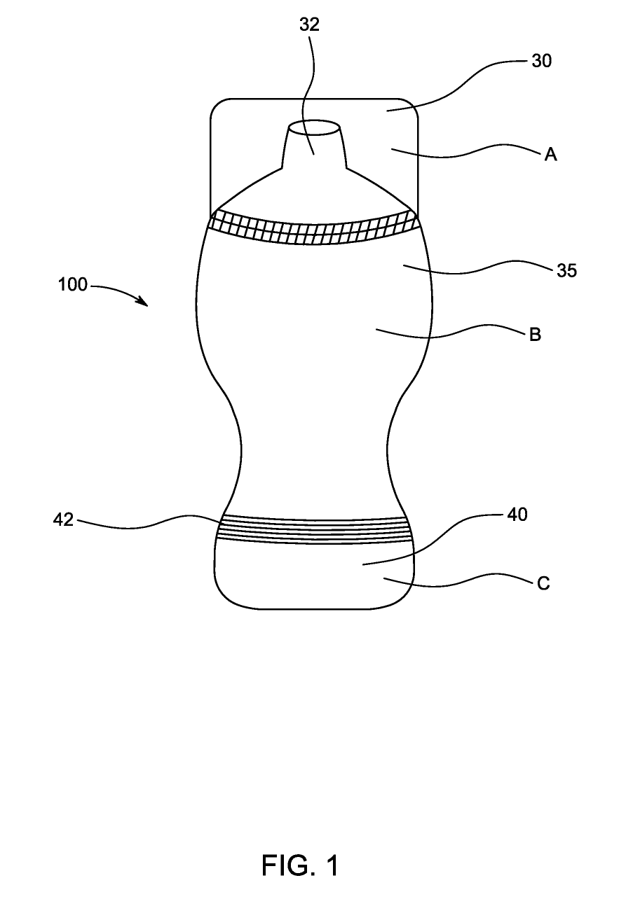

In reference to FIG. 1, a Bottle 100 in accordance with the present invention is depicted. The bottle 100 includes a main Portion 35 and a formula Portion 30 at the bottom of the bottle 100 as shown in FIG. 1. This formula Portion 30 is removable and preferably attached with a threaded Connection 42. Once removed the formula contained within this formula Portion 30 is released and mixed with water that may be contained in a liquid Portion 35. The liquid Portion 35 may be adjusted for various sizes as needed for mixing with formula contained within the formula Portion 40. The bottle 100 further includes a Nipple 32 and a Clear Cap 30 that remains over the Nipple 32 until mixture and consumption is desired by the parent or caregiver. The present invention provides a convenient and an effective manner to transport, store and consume baby formula.

What is claimed:

1. A bottle for baby formula comprising:
a main liquid portion;
a formula portion attached to the liquid portion, where the formula portion includes an infant formula for consumption and is adapted for removal;
an attachment means that provides a means to attach the formula portion to the liquid portion of the bottle;
a nipple; and
a removable cap, where the removable cap covers the nipple.

2. The bottle for baby formula according to claim 1, where the attachment means is a threaded connection.

3. The bottle for baby formula according to claim 1, where the liquid portion includes a curved outer surface.

4. The bottle for baby formula according to claim 1, where the infant formula is a premixed powder.
